(19) United States
(12) Patent Application Publication
(10) Pub. No.: US 2024/0119296 A1
(43) Pub. Date: Apr. 11, 2024

(54) LEARNING DEVICE, LEARNING METHOD, AND RECORDING MEDIUM

(71) Applicant: NEC Corporation, Minato-ku, Tokyo (JP)

(72) Inventors: Akira TANIMOTO, Tokyo (JP); Tomoya SAKAI, Tokyo (JP); Takashi TAKENOUCHI, Saitama (JP); Hisashi KASHIMA, Kyoto (JP)

(73) Assignee: NEC Corporation, Minato-ku, Tokyo (JP)

(21) Appl. No.: 18/276,290

(22) PCT Filed: Jun. 7, 2021
(86) PCT No.: PCT/JP2021/021609

§ 371 Date: Aug. 8, 2023

(30) Foreign Application Priority Data
Feb. 26, 2021 (JP) 2021-031172

(51) Int. Cl. G06N 3/09

(52) U.S. Cl. CPC G06N 3/09

(57) ABSTRACT

A learning device calculates an estimation target item reference value according to a fixed value of each estimation target object. The learning device acquires learning data that includes the fixed value of each estimation target object, a variable item value, and an estimation target item value according to the fixed value and the variable item value. The learning device trains, using the learning data and an evaluation function, a model that outputs an estimated value of the estimation target item value in response to input of the fixed value of each estimation target object and the variable item value.

### TECHNICAL FIELD

This invention relates to a learning device, a learning method, and a recording medium.

### BACKGROUND ART

Technologies have been proposed related to learning, such as presenting candidates for causal relationships in machine learning (for example, Patent Document 1).

### PRIOR ART DOCUMENTS

### Patent Documents

Patent Document 1: Japanese Unexamined Patent Application Publication No. 2019-194849

### SUMMARY OF THE INVENTION

### Problems to be Solved by the Invention

If the model obtained through learning is expected to be used for decision making, it is conceivable that fixed values specific to each target, such as the feature of each target, as well as variable values will be used as inputs to the model. In such a case, it is assumed that the distribution of variable values may differ between learning and decision making. Thus, it may be required to learn the model with the assumption that the variable values are changed to simulate the results.

One of the objects of the present invention is to provide a learning device, a learning method, and a recording medium that can solve the above-mentioned problems.

### Means for Solving the Problem

According to the first example aspect of the invention, a learning device includes: a reference value calculation means that calculates an estimation target item reference value according to a fixed value of each estimation target object; a learning data acquisition means that acquires learning data that includes the fixed value of each estimation target object, a variable item value, and an estimation target item value according to the fixed value and the variable item value; and a learning means that trains, using the learning data and an evaluation function, a model that outputs an estimated value of the estimation target item value in response to input of the fixed value of each estimation target object and the variable item value, the evaluation function giving a high evaluation when the estimated value is equal to or greater than the estimation target item reference value and the estimation target item value is equal to or greater than the estimation target item reference value, and when the estimated value is less than the estimation target item reference value and the estimation target item value is less than the estimation target item reference value.

According to the second example aspect of the invention, a learning device includes: a learning means that trains a model that outputs a feature expression in response to an input of a fixed value for each estimation target object and a variable item value so that an inter-distribution distance between distribution of the feature expressions output by the model in response to an input of the fixed value for each estimation target object and the variable item value included in the learning data and distribution of the feature expressions output by the model in response to an input of the fixed value for each estimation target object and the variable item value randomly selected based on a uniform distribution is reduced.

According to the third example aspect of the invention, a learning device includes: a learning means that uses an evaluation function including an evaluation index of independence between distribution of a first feature expression output by a first model in response to input of a fixed value for each estimation target object and distribution of a second feature expression output by a second model in response to input of a variable item value to train at least one of the first model or the second model so that the independence indicated by the evaluation index becomes higher.

According to the fourth example aspect of the invention, a learning device includes: a reference value calculation means that calculates an estimation target item reference value according to a fixed value of each estimation target object; a learning data acquisition means that acquires learning data that includes the fixed value for each estimation target object, a variable item value, and a difference between an estimation target item value according to the fixed value and the variable item value, and the estimation target item reference value; and a learning means that trains, by using the learning data, a model that outputs an estimated value of the difference between the estimation target item value and the estimation target item reference value in response to an input of a fixed value for each estimation target object and a variable item value.

According to the fifth example aspect of the invention, a learning method includes: calculating an estimation target item reference value according to a fixed value of each estimation target object; acquiring learning data that includes the fixed value of each estimation target object, a variable item value, and an estimation target item value according to the fixed value and the variable item value; and training, using the learning data and an evaluation function, a model that outputs an estimated value of the estimation target item value in response to input of the fixed value of each estimation target object and the variable item value, the evaluation function giving a high evaluation when the estimated value is equal to or greater than the estimation target item reference value and the estimation target item value is equal to or greater than the estimation target item reference value, and when the estimated value is less than the estimation target item reference value and the estimation target item value is less than the estimation target item reference value.

According to the sixth example aspect of the invention, a learning method includes: training a model that outputs a feature expression in response to an input of a fixed value for each estimation target object and a variable item value so that an inter-distribution distance between distribution of the feature expressions output by the model in response to an input of the fixed value for each estimation target object and the variable item value included in the learning data and distribution of the feature expressions output by the model in response to an input of the fixed value for each estimation target object and the variable item value randomly selected based on a uniform distribution is reduced.

According to the seventh example aspect of the invention, a learning method includes: using an evaluation function including an evaluation index of independence between distribution of a first feature expression output by a first model in response to input of a fixed value for each estimation target object and distribution of a second feature expression output by a second model in response to input of a variable item value to train at least one of the first model or the second model so that the independence indicated by the evaluation index becomes higher.

According to the eighth example aspect of the invention, a recording medium that stores a program for causing a computer to execute: calculating an estimation target item reference value according to a fixed value of each estimation target object; acquiring learning data that includes the fixed value of each estimation target object, a variable item value, and an estimation target item value according to the fixed value and the variable item value; and training, using the learning data and an evaluation function, a model that outputs an estimated value of the estimation target item value in response to input of the fixed value of each estimation target object and the variable item value, the evaluation function giving a high evaluation when the estimated value is equal to or greater than the estimation target item reference value and the estimation target item value is equal to or greater than the estimation target item reference value, and when the estimated value is less than the estimation target item reference value and the estimation target item value is less than the estimation target item reference value.

According to the ninth example aspect of the invention, a recording medium that stores a program for causing a computer to execute: training a model that outputs a feature expression in response to an input of a fixed value for each estimation target object and a variable item value so that an inter-distribution distance between distribution of the feature expressions output by the model in response to an input of the fixed value for each estimation target object and the variable item value included in the learning data and distribution of the feature expressions output by the model in response to an input of the fixed value for each estimation target object and the variable item value randomly selected based on a uniform distribution is reduced.

According to the tenth example aspect of the invention, a recording medium that stores a program for causing a computer to execute: calculating an estimation target item reference value according to a fixed value of each estimation target object; acquiring learning data that includes the fixed value for each estimation target object, a variable item value, and a difference between an estimation target item value according to the fixed value and the variable item value, and the estimation target item reference value; and training, by using the learning data, a model that outputs an estimated value of the difference between the estimation target item value and the estimation target item reference value in response to an input of a fixed value for each estimation target object and a variable item value.

### Effect of Invention

According to the present invention, when fixed values and variable values are input to a model for each target of learning, it is possible to perform model training corresponding to those inputs.

### BRIEF DESCRIPTION OF THE DRAWINGS

FIG. 1 is a diagram showing an example of the schematic configuration of a learning device according to the example embodiment.

FIG. 2 is a diagram showing a first example of the inputs and outputs of the model handled by the learning device according to the example embodiment.

FIG. 3 is a diagram showing a second example of the inputs and outputs of the model handled by the learning device according to the example embodiment.

FIG. 4 is a diagram explaining the difference in the distribution of input data to a model during learning and operation according to the example embodiment.

FIG. 5 is a diagram showing a third example of the inputs and outputs of a model handled by the learning device according to the example embodiment.

FIG. 6 is a diagram showing a fourth example of the inputs and outputs of a model handled by the learning device according to the example embodiment.

FIG. 7 is a diagram showing a second example of the configuration of the learning device according to the example embodiment.

FIG. 8 is a diagram showing a third example of the configuration of the learning device according to the example embodiment.

FIG. 9 is a diagram showing a fourth example of the configuration of the learning device according to the example embodiment.

FIG. 10 is a diagram showing a fifth example of the configuration of the learning device according to the example embodiment.

FIG. 11 is a flowchart showing a first example of the processing procedure in the learning method according to the example embodiment.

FIG. 12 is a flowchart showing a second example of the processing procedure in the learning method according to the example embodiment.

FIG. 13 is a flowchart showing a third example of the processing procedure in the learning method according to the example embodiment.

FIG. 14 is a flowchart showing a fourth example of the processing procedure in the learning method according to the example embodiment.

FIG. 15 is a schematic block diagram showing the configuration of the computer according to at least one example embodiment.

### EXAMPLE EMBODIMENTS

The following is a description of the example embodiments of the present invention, but the following example embodiments are not intended to limit the scope of the invention as claimed. Moreover, not all of the combinations of features described in the example embodiments may not be essential to the solution of the invention.

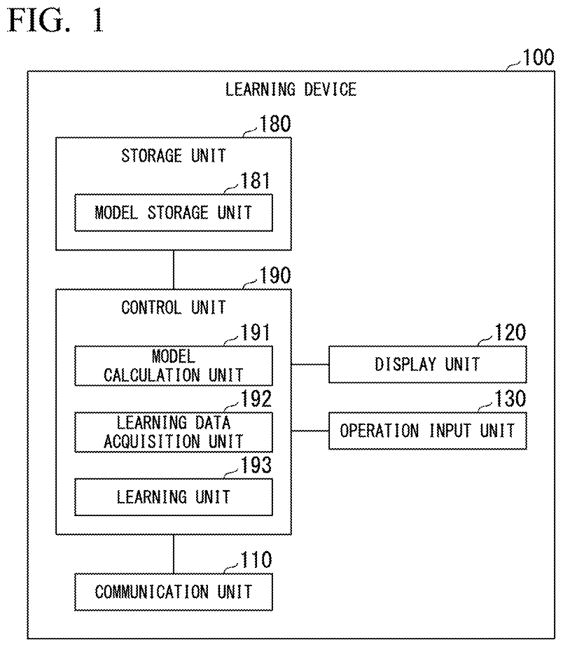

FIG. 1 is a diagram showing an example of the schematic configuration of the learning device according to the example embodiment. In the configuration shown in FIG. 1, a learning device 100 includes a communication unit 110, a display unit 120, an operation input unit 130, a storage unit 180, and a control unit 190. The storage unit 180 includes a model storage unit 181. The control unit 190 includes a model calculation unit 191, a learning data acquisition unit 192, and a learning unit 193.

The learning device 100 performs learning of a model. The learning device 100 may be configured using a computer, such as a personal computer (PC) or a workstation.

The communication unit 110 communicates with other devices. For example, the communication unit 110 may be configured to receive learning data from other devices. If the model is external to the learning device 100, the communication unit 110 may be configured to send input data to the model to instruct calculation and receive the output of the model.

The display unit 120 includes a display screen, such as a liquid crystal panel or LED (Light Emitting Diode) panel, for example, and displays various images. For example, the display unit 120 may be configured to display the output of the model.

The operation input unit 130 includes input devices such as a keyboard and mouse, for example, and receives user operations. For example, the operation input unit 130 may receive a user operation indicating the start of model learning.

The storage unit 180 stores various data. The storage unit 180 is configured using the storage device provided in the learning device 100.

The model storage unit 181 stores models. However, the models that the learning device 100 targets for learning are not limited to those stored by the model storage unit 181. For example, the model that the learning device 100 targets for learning may be configured using dedicated hardware. The model that the learning device 100 targets for learning may be configured as a separate device from the learning device 100.

The control unit 190 controls the various parts of the learning device 100 and executes various processes. The functions of the control unit 190 are performed, for example, by the CPU (Central Processing Unit) provided by the learning device 100, which reads a program from the memory unit 180 and executes it.

The model calculation unit 191 performs model-based calculations. For example, if the model storage unit 181 stores a software-configured model, the model calculation unit 191 may read the model software from the model storage unit 181 and perform calculations. Alternatively, if the model is configured external to the learning device 100, the model calculation unit 191 may instruct the model to perform calculations via the communication unit 110.

The learning data acquisition unit 192 acquires learning data. For example, the learning data acquisition unit 192 may acquire learning data from other devices via the communication unit 110.

The learning unit 193 performs model learning. The learning unit 193 may perform model learning using a known method.

For the model handled by the learning device 100, assume that there are multiple targets for estimation by the model, with fixed values for each target and variable items whose values can be changed for each target. Each of the objects of estimation by the model is referred to as an estimation target object. Estimation by the model here means that the model that does not know the correct value of the output outputs the value. Estimation here may also be a prediction, but is not limited thereto. For example, the model handled by the learning device 100 may be used to make predictions with respect to the object and variable item values, or used to evaluate variable item values in the object, but is not limited to these applications.

The fixed value for each estimation target object is denoted by x, and the variable item value (the value of the variable item) is denoted by a.

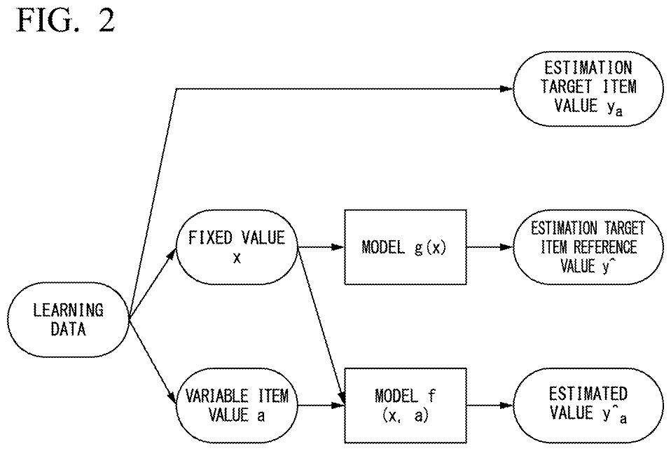

FIG. 2 is a diagram that shows a first example of the inputs and outputs of the model handled by the learning device 100.

In the example in FIG. 2, a model f receives an input of fixed value x and variable item value a and outputs an estimated value. The model f is also denoted f(x,a). The estimated value output by model f is the estimated value when the variable item value a is set for the estimation target object identified by the fixed value x. This estimated value is denoted y\hat{ }ₐ. The estimation target item value yₐ corresponds to the actual value for the estimated value y\hat{ }ₐ.

The estimation target item here is the item to be output by the model as an estimation result, namely, the outcome. The estimation target item value is the actual value (measurement value) for the outcome.

A model g outputs the estimation target item reference value upon receiving input of the fixed value x. The estimation target item reference value is denoted as y\hat{ }. The model g is also denoted as g(x).

The estimation target item reference value y\hat{ } is a value determined for each estimation target object and represents the average value of the estimation target item value yₐ for each estimation target object. Specifically, the estimation target item reference value y\hat{ }can be regarded as an estimated value obtained by taking the conditional expectation value relating to a past decision maker's variable item value selection given a fixed value x, for the estimation target item value yₐ obtained for each variable item value a, for one estimation target object. The estimation target reference value is the reference value for the outcome.

The model calculation unit 191, which calculates the value of the model g, is an example of a reference value calculation means. In other words, the model calculation unit 191 uses the model g to calculate the estimation target item reference value y\hat{ }according to the fixed value x for each estimation target object.

The learning unit 193, for example, performs learning of the model g using the fixed value x and the estimation target item value yₐ among the learning data resulting from a combination of the fixed value x, the variable item value a, and the estimation target item value yₐ while ignoring the variable item value a. Ignoring the variable item value a here means that variable item value a is not used as an input to the model g.

Thus, since the learning unit 193 may perform learning of model g using the estimation target item value yₐ as the correct answer, the estimation target item reference value y\hat{ }, which is the output value of model g, corresponds to the estimated value of the estimation target item value yₐ by the model g.

The estimation target object, the fixed value x and the variable item value a are not limited to any particular one. The data format of each of the fixed value x and variable item value a is not limited to a particular one.

For example, the estimation target object may be a store, such as a retail store, and the fixed value x may be a characteristic value specific to each store, such as the location of the store. The variable item value a may be an action that can be implemented in each store, such as product assortment in a store. The estimated value y\hat{ }ₐ can be a value that can be obtained for each store based on its assortment of products, such as sales at each store. The estimation target item reference value y\hat{ }can be regarded, for example, as the average sales per store.

Alternatively, the estimation target objects are persons, and the fixed value x may be a characteristic value specific to each individual, such as the gender and age of each individual. The variable item value a may be a behavior that each individual can perform, such as whether or not they smoke. The estimated value y\hat{ }ₐ can be a value that can be determined for each individual according to their behavior, such as an evaluation value of each individual's health. The estimation target item reference value y\hat{ }can be regarded, for example, as an evaluation value of health in the case where an average behavior is assumed for each individual.

One possible use of the model f is to find a variable item value a such that the estimated value f(x,a)=y\hat{ }ₐ is large. For example, if the estimated value y\hat{ }ₐ represents the sales of each store, it is conceivable to seek an assortment a such that sales y\hat{ }ₐ is large in a given store.

In this case, it is considered preferable to perform learning of the model fin such a way to avoid situations where the actual value (estimation target item value y a) is small even though the estimated value y\hat{ }ₐ is large. Therefore, the learning unit 193 may perform learning of the model f using an evaluation function that gives a higher evaluation the smaller the value of ER shown in Expression (1).

$$\begin{matrix}[ Expression 1 ] & \\ E R = - \frac{1}{N} \sum ( s log ( v ) + ( 1 - s ) log ( 1 - v ) ) & ( 1 )\end{matrix}$$

log represents the logarithmic function. N indicates the number of samples used for learning. Here, a sample refers to an individual sample in the learning data. For example, the combination of the fixed value x in one estimation target object, one variable item value a set for that estimation target object, and an estimation target item value y that is the correct answer for that fixed value x and that variable item value a may constitute one sample.

The learning data acquisition unit 192, which acquires learning data including this sample, corresponds to an example of a learning data acquisition means. That is, the learning data acquisition unit 192 acquires learning data that includes the fixed value x for each estimation target object and the variable item value a, and an estimation target item value yₐ according to that fixed value x and that variable item value a.

s is shown in Expression (2).

[Expression 2]

s=I(y−g(x)≥0) (2)

Here y represents the estimation target item value in the sample and indicates the correct value of the output of model f for the fixed value x and variable item value a identified by the sample.

As mentioned above, the model g is a learned model of the relationship between the fixed value x and estimation target item value y. The value of the model g is used as the average of the estimation target item value y when the fixed value x is determined.

I is a function that takes the value 1 when the argument value is true and takes the value 0 when the argument value is false. Therefore, the value of I(y−g(x)≥0) is 1 when y≥g(x) and 0 when y<g(x).

v is expressed as in Expression (3).

[Expression 3]

v=σ(f(x,a)−g(x)) (3)

σ represents the sigmoid function. Therefore, v takes the value 0<v<1, and “log(v)” in Expression (1) takes a negative value. That is, log(v)<0. The larger the value of f(x,a)−g(x), the larger the value of “log(v)”. In other words, the larger the value of f(x,a)−g(x), the more the magnitude |log(v)| of “log(v)” becomes a small negative value.

From Expression (2), when y<g(x), s=0, and the value of “s log(v)” in Expression (1) is 0. On the other hand, when y≥g(x) and f(x,a)<g(x), the value of “s log(v)” will be a relatively small negative value, and when y≥g(x) and f(x,a)≥g(x), the value of “s log(v)” will be a relatively large negative value. As described above, a small negative value means a negative value with a large magnitude (absolute value), and a large negative value is a negative value with a small magnitude (absolute value).

Thus, the value of “s log(v)” in Expression (1) is a relatively small negative value when y≥g(x) and f(x,a)<g(x), otherwise it is 0 or a negative value close to 0 (relatively large negative value).

From Expression (3), 1−v takes a value of 0<1−v<1, and “log(1−v)” in Expression (1) takes a negative value. The larger the value of f(x,a)−g(x), the smaller the value of 1−v and the smaller the value of “log(1−v)”. In other words, the larger the value of f(x,a)−g(x), the more the magnitude |log(1−v)| of “log(1−v)” becomes a large negative value.

From Expression (2), when y≥g(x), 1−s=0, and the value of “(1−s)(1−log(v))” in Expression (1) is 0. On the other hand, when y<g(x) and f(x,a)≥g(x), the value of “(1−s)(1−log(v))” becomes a relatively small negative value, and when y<g(x) and f(x,a)<g(x), the value of “(1−s)(1−log(v))” becomes a relatively large negative value.

Thus, the value of “(1−s)(1−log(v))” in Expression (1) is a relatively small negative value when y<g(x) and f(x,a)≥g(x), otherwise it is 0 or a negative value close to 0 (relatively large negative value).

Accordingly, the larger the proportion of samples used to learn the model f that satisfy “(y≥g(x) and f(x,a)<g(x)) or (y<g(x) and f(x,a)≥g(x))”, the larger the value of ER. Therefore, the learning unit 193 performs learning of the model f(x,a) so that the value of ER becomes smaller, whereby it is expected that y≥g(x) if f(x,a)≥g(x) and y<g(x) if f(x,a)<g(x).

As mentioned above, the output of the model g(x) is used as the estimation target item value y\hat{ }. Therefore, the evaluation function, which gives a higher evaluation the smaller the value of ER, corresponds to an example of an evaluation function that gives a higher evaluation when the estimated value y\hat{ }ₐ is equal to or greater than the estimation target item reference value y\hat{ } and the estimation target item value yₐ is equal to or greater than the estimation target item reference value y\hat{ }, and when the estimated value y\hat{ }ₐ is less than the estimation target item reference value y\hat{ } and the estimation target item value yₐ is less than the estimation target item reference value y\hat{ }.

The evaluation function, which gives a high evaluation when the estimated value y\hat{ }ₐ is equal to or greater than the estimation target item reference value y\hat{ } and the estimation target item value yₐ is equal to or greater than estimation target item reference value y\hat{ }, and when the estimated value y\hat{ }ₐ is less than the estimation target item reference value y\hat{ } and the estimation target item value yₐ is less than the estimation target item reference value y\hat{ } may be an evaluation function that gives a higher evaluation the greater the proportion of the total of the samples in which the estimated value y\hat{ }ₐ is equal to or greater than the estimation target item reference value y\hat{ } and the estimation target item value yₐ is equal to or greater than the estimation target item reference value y\hat{ }, and the samples in which the estimated value y\hat{ }ₐ is less than the estimation target item reference value y\hat{ } and the estimation target item value yₐ is less than the estimation target item reference value y\hat{ }, with respect to the number samples used in learning of the model f.

As described above, the learning unit 193 may perform learning of the model f using an evaluation function that gives a higher evaluation the smaller the value of ER.

For example, the learning unit 193 may performing learning of the model f using the evaluation function shown in Expression (4), where the smaller the value of L, the higher the evaluation.

[Expression 4]

L=\sqrt{MSE·ER} (4)

MSE represents the Mean Squared Error between the evaluation item estimated value y\hat{ }ₐ, which is the output of the model f, and the evaluation item value y which is the correct answer. The smaller the value of L, the smaller the mean squared error between the evaluation item estimated value y\hat{ }ₐ and the evaluation item value y, and in this respect, the model f is more accurate. Moreover, the smaller the value of L, the more likely it is that y≥g(x) when f(x,a)≥g(x) and y<g(x) when f(x,a)<g(x), as discussed above for ER.

When the learning unit 193 performs learning of the model f using an evaluation function in which the smaller the function value, the higher the evaluation (i.e., a loss function), the learning unit 193 may use an evaluation function that includes L as one of the terms, or an evaluation function that includes a term obtained by multiplying L by a positive coefficient.

When the learning unit 193 performs learning of the model f using an evaluation function in which the larger the function value, the higher the evaluation, the learning unit 193 may use an evaluation function that includes −L as one of the terms, or an evaluation function that includes a term obtained by multiplying L by a negative coefficient.

The process of calculating the value of L is not limited to the process of calculating the geometric mean shown in Expression (4), but may be, for example, a process of calculating an arithmetic mean or a weighted mean.

Here, the finding was obtained that Expression (5) holds.

$$\begin{matrix}[ Expression 5 ] & \\ Regret @ k \leq \frac{\vert Action Set \vert}{k} \sqrt{Uniform M S E \cdot Top - k Error} & ( 5 )\end{matrix}$$

“Regret@k” indicates the difference between the mean of the estimation target item value yₐ corresponding to the variable item value a that are any of the variable item values a from the variable item value a with the largest estimated value y\hat{ }ₐ to the variable item value a with the kth largest estimated value y\hat{ }ₐ among the variable item values a for which the estimation target item value yₐ is obtained, that is, the variable item value a for which the estimated value y\hat{ }ₐ is any of the top k, and the mean of the true top k estimation target item values yₐ.

The “|Action Set|” indicates the number of elements (i.e., the number of parameters that can be set) of the variable item value a.

The “k” in the denominator of the fraction indicates the “k” in the number of variable item values a in Regret@k.

“Uniform MSE” indicates the mean squared error between the estimation target item value yₐ and the estimated value y\hat{ }ₐ when the variable item value a follows a uniform distribution.

The “Top-k Error” indicates the proportion of variable item values a for which the inverse relationship holds between whether or not the estimated value y\hat{ }ₐ is within the top k values and whether or not the estimation target item value yₐ is within the top k values.

The number of variable item values a for which the inverse relationship holds between whether or not the estimated value y\hat{ }, is within the top k values and whether or not the estimation target item value yₐ is within the top k values is the total of the number of variable item values a for which the estimated value y\hat{ }, is within the top k values and the estimation target item value yₐ is not within the top k values and the number of variable item values a for which the estimated value y\hat{ }ₐ is not within the top k values and the estimation target item value yₐ is within the top k values.

By using L shown in Expression (4), if all the true estimation target item values are known for each variable item value, it is possible to approximately control the difference (Regret@k) between the mean of the evaluation item values that would have been obtained by selecting from the top k values and the mean in the case of selecting from the top k values based on the estimation, based on Expression (5). This “difference” is referred to as “regret” and the notation “Regret@k” is used.

The learning unit 193 first performs learning of the model g using the learning data. After the learning unit 193 completes the learning of the model g, the model calculation unit 191 calculates the estimation target item reference value y\hat{ } for each sample of learning data, and the learning data acquisition unit 192 generates learning data including the estimation target item reference value y\hat{ } for that sample. The learning unit 193 performs learning of the model f using the learning data that includes the estimation target item reference value y\hat{ }. Alternatively, each time the learning unit 193 applies a sample to the learning of the model f, the model calculation unit 191 may calculate the output of the model g (i.e., the estimation target item reference value y\hat{ }) in the case of that sample.

As described above, the model calculation unit 191 calculates the estimation target item reference value y\hat{ }according to the fixed value x for each estimation target object. The learning data acquisition unit 192 acquires learning data that includes a fixed value x for each estimation target object, a variable item value a, and an estimation target item value yₐ according to that fixed value x and that variable item value a. The model f outputs the estimated value y\hat{ }ₐ of the estimation target item value yₐ in response to the input of the fixed value x of each estimation target object and the variable item value a. The learning unit 193 performs learning of the model f using the learning data acquired by the learning data acquisition unit 192 and an evaluation function whose evaluation is higher when the estimated value y\hat{ }ₐ is equal to or greater than the estimation target item reference value y\hat{ } and the estimation target item value yₐ is equal to or greater than the estimation target item reference value y\hat{ }, and when the estimated value is less than the estimation target item reference value y\hat{ } and the estimation target item value yₐ is less than the estimation target item reference value y\hat{ }.

The learning unit 193 is an example of a learning means. The evaluation function which gives a higher evaluation the smaller the value of ER of Expression (1) is, or the evaluation function which gives a higher evaluation the smaller the value of L of Expression (4) is, corresponds to an example of an evaluation function whose evaluation is higher when the estimated value y\hat{ }ₐ is equal to or greater than the estimation target item reference value y\hat{ } and the estimation target item value yₐ is equal to or greater than the estimation target item reference value y\hat{ }, and when the estimated value is less than the estimation target item reference value y\hat{ } and the estimation target item value yₐ is less than the estimation target item reference value y\hat{ }.

y≥g(x) when f(x,a)≥g(x), and y<g(x) when f(x,a)<g(x) as described above corresponds to an example of the case of the estimated value y\hat{ }ₐ being equal to or greater than the estimation target item reference value y\hat{ } and the estimation target item value y a being equal to or greater than the estimation target item reference value y\hat{ }, and the case of the estimated value being less than the estimation target item reference value y\hat{ } and the estimation target item value yₐ being less than the estimation target item reference value y\hat{ }.

According to the learning device 100, it is expected that the actual value (estimation target item value y a) is unlikely to be small even though the output of the model f (estimated value y\hat{ }ₐ) is large. According to the learning device 100, in this respect, when fixed values and variable values are input to a model for each target of learning, it is possible to perform model training corresponding to those inputs.

The model calculation unit 191 calculates the estimation target item reference value y\hat{ }using the model g. The model g corresponds to an example of a model that outputs an estimate of the estimation target item value y in response to an input of the fixed value x of each estimation target object by learning using the fixed value x of each estimation target object and the estimation target item value y as the learning data.

According to the learning device 100, learning of the model g(x) can be performed more easily than learning of the model f(x,a), in that the estimation target item reference value y\hat{ }can be calculated by inputting the fixed value x to the model g. In particular, in the learning of the model f(x,a), it is required to perform the learning so that the required estimation accuracy can be obtained even outside of the distribution p(x,a) of the learning data. In contrast, in learning the model g(x), since changes in the variable item value a do not affect learning, it is sufficient to perform learning to obtain the required estimation accuracy for the distribution of past data.

According to the learning device 100, in terms of obtaining the average value of the estimation target item value yₐ as the estimation target item reference value y\hat{ }, a suitable value can be obtained as a comparison target with the estimated value y\hat{ }ₐ and a comparison target with the estimation target item value yₐ. If the estimation target item reference value y\hat{ }is significantly larger than the estimation target item value yₐ, the comparison may become meaningless because the condition y\hat{ }>yₐ is always satisfied. In contrast, the model calculation unit 191 can obtain an average value of the estimation target item value yₐ as the estimation target item reference value y\hat{ }, thereby avoiding the meaningless comparison described above.

The learning unit 193 uses the aforementioned evaluation function that includes the product of a step function that takes a value corresponding to whether the estimation target item value yₐ is equal to or greater than the estimation target item reference value y\hat{ } or whether the estimation target item value yₐ is less than the estimation target item reference value y\hat{ }, and a monotonic and differentiable function in relation to a difference obtained by subtracting the estimation target item reference value y\hat{ } from the output of the model f (estimated value y\hat{ }ₐ) in response to the inputs of the fixed value x for each estimation target object and the variable item value a. It is sufficient that the “difference” represent the difference between the output of model f and the estimation target item reference value y\hat{ }. The same applies thereafter.

The value of “I(y−g(x)≥0)” in Expression (2) is 0 when y<g(x) and 1 when y≥g(x). “I(y−g(x)≥0)” corresponds to an example of a step function.

According to the learning device 100, by using a differentiable function as the evaluation function as described above, namely by using a differentiable function with respect to the input of the variable item value a, it is possible to apply well-known learning methods such as backpropagation.

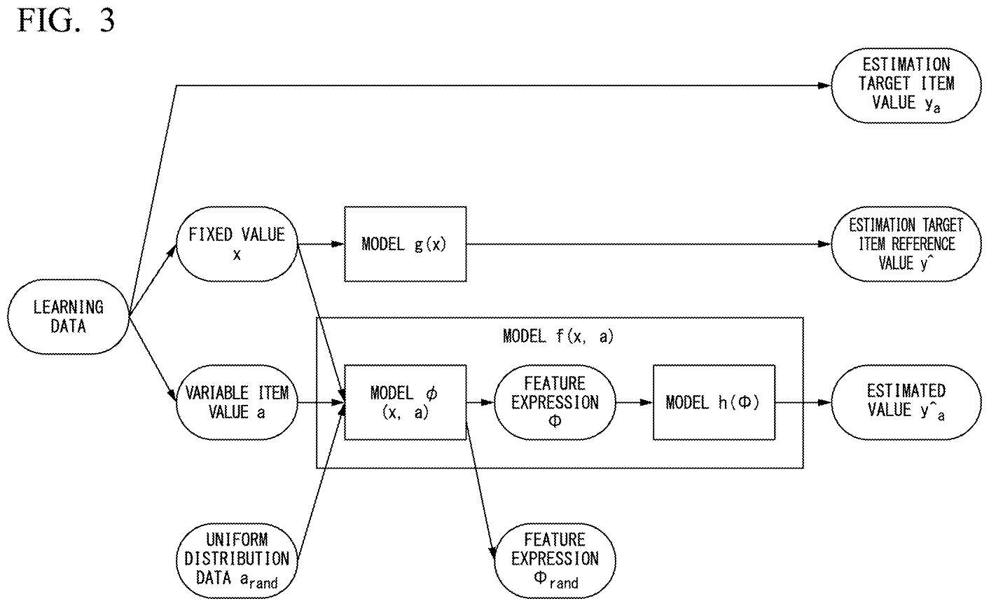

FIG. 3 is a diagram that shows a second example of the inputs and outputs of the model handled by the learning device 100.

In the example of FIG. 3, the model φ receives inputs of fixed values x and variable item values a and outputs a feature expression. The model φ is also denoted as φ(x,a). The feature expression output by model φ is data that shows the characteristics of the fixed value x and variable item value a, which are the input data to the model φ. This feature expression is denoted as Φ. The feature expression may be indicated by a real vector. The real vector in this case is also referred to as the feature vector. A feature expression is also referred to as a feature.

Model h receives the input of the feature expression Φ and outputs the estimated value y\hat{ }ₐ. Model h is also denoted as h(Φ).

The combination of model φ and model h constitutes model f.

In the example in FIG. 3, the learning unit 193 performs learning of models (especially learning of model φ) to accommodate differences in the distribution of input data between learning and operation of model φ and model h.

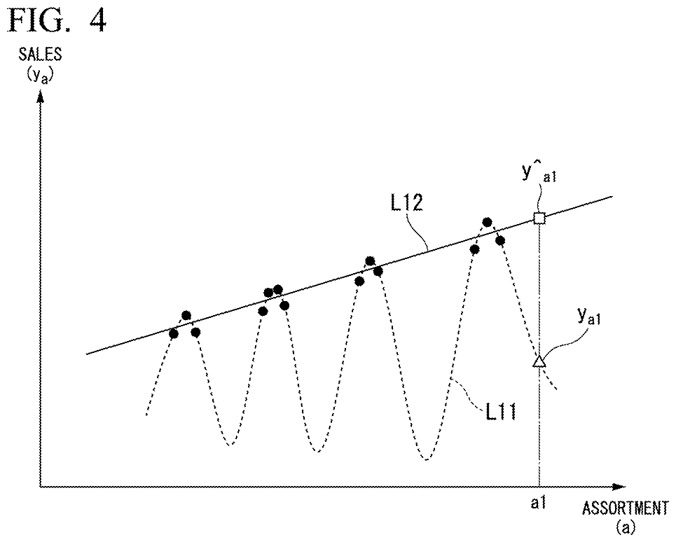

FIG. 4 is a diagram for explaining the difference in the distribution of input data to models during learning and operation.

FIG. 4 shows an example of the relationship between product assortment and sales in one store. The horizontal axis of the graph in FIG. 4 shows the product assortment. To make the figure easier to read, FIG. 4 shows the product assortment in one dimension. The product assortment corresponds to the example of variable item value a.

The vertical axis of the graph in FIG. 4 shows sales. Sales are an example of the estimation target item value yₐ.

Line L11 shows an example of the actual relationship between product assortment and sales. An example of measurement data of the relationship between product assortment and sales is shown by a black circle on line L11. Line L12 shows an example of a model that linearly approximates the measurement values of sales against product assortment.

Here, the product assortment when measurement data is measured is considered by the store manager as a suitable assortment, and the case being considered is one in which the measurement data is biased toward the side with high (large) sales, as shown in FIG. 4.

As such, the model does not reflect the relationship between product assortment and sales when sales are low (small), which may result in low model accuracy. For example, assume that the store manager, in an attempt to determine a product assortment that will result in higher sales, decides on product assortment a1 based on the point y\hat{ }ₐ₁ shown on line L12. In this case, the actual sales are the sales represented by point yₐ₁ on line L11, which would be significantly lower than the sales estimated by the store manager, indicated by point y\hat{ }ₐ₁.

In contrast, the model is expected to be more accurate if the relationship shown in the measurement data can be reflected, even for input data for which sufficient measurement data is not available.

Therefore, the learning unit 193 performs learning of the model φ using uniform distribution data that is randomly sampled based on a uniform distribution (equal distribution) for the variable items. The uniform distribution data is denoted as a_{rand}.

The learning unit 193 performs learning of the model φ so that the distribution of the feature expression Φ is the same when the variable item value a in the learning data is used and when the uniform distribution data a_{rand} is used.

The feature expression Φ when using the variable item value a included in the learning data is the feature expression Φ output by the model Φ upon receiving the input of the combination of the variable item value a and the fixed value x in the sample of learning data. The feature expression Φ for the case of uniform distribution data a_{rand} is the feature expression Φ output by the model φ in response to receiving the input of the combination in which the variable item value a is replaced by the uniform distribution data a_{rand}, from the combination of the variable item value a and fixed value x included in the sample of learning data.

Here, the feature expression when using the uniform distribution data a_{rand} is denoted as grana to distinguish it from the feature expression Φ when using the variable item value a included in the learning data.

The learning unit 193 further performs learning of the model h using the learning data in which the feature expression Φ output by the learned model φ in response to receiving the input of the combination of the fixed value x and variable item value a included in the sample of learning data and the estimation target item value y a included in that sample are associated.

The variable item value a included in the learning data is transformed by the model φ into the feature expression Φ that shows the same distribution as the feature expression Φ_{rand} in the case of the uniform distribution data a m id. This allows the learning unit 193 to perform learning of the model h so that the model h reflects the relationship between the variable item value a and the estimation target item value y a included in the learning data, not only for the variable item value a indicated in the learning data, but for the entire distribution of the variable item value a. In this respect, the accuracy of the model f resulting from the combination of the model φ and the model h is expected to be high.

The method by which the learning data acquisition unit 192 acquires the uniform distribution data a_{rand} is not limited to a specific method. For example, the learning data acquisition unit 192 may acquire, as the uniform distribution data a m id, data randomly selected by a model with uniform distribution of the variable item value a. Alternatively, the learning data acquisition unit 192 may acquire uniform distribution data a_{rand} created by a person, such as a user of the learning device 100.

Instead of the learning data acquisition unit 192, the learning unit 193 may acquire the uniform distribution data a m id.

With regard to learning the model φ, the learning unit 193 may perform learning of the model φ such that the inter-distribution distance between the distribution of the feature expression Φ and the distribution of the feature expression Dana is small. For example, the learning unit 193 may perform learning of the model φ to minimize the inter-distribution distance using an evaluation function that includes the inter-distribution distance of the distribution of the feature expression Φ and the distribution of the feature expression Φ_{rand}. The learning unit 193 may perform learning of the model φ such that the inter-distribution distance between the distribution of the feature expression Φ and the distribution of the feature expression Dram is equal to or less than a predetermined threshold.

In this case, the inter-distribution distance is as shown in Expression (6).

[Expression 6]

D_{IPM}({ϕ(x,a)},{ϕ(x,a_{rand})}) (6)

The D_{IPM} (Integral Probability Metric) indicates the inter-distribution distance between the two distributions shown in the argument. “{φ(x,a)}” denotes the set of feature expressions Φ output by the model φ when using the variable item value a included in the learning data. “{φ(x, a_{rand})}” indicates the set of feature expressions Φ_{rand} output by the model φ when uniform distribution data a_{rand} is used.

The inter-distribution distance is an index indicating the degree of agreement between two distributions. The inter-distribution distance used by the learning unit 193 is not limited to a specific one. For example, the learning unit 193 may use the Maximum Mean Discrepancy (MMD) or Wasserstein distance as the inter-distribution distance, but is not limited thereto.

As described above, the model φ outputs a feature expression Φ in response to the input of the fixed value x of each estimation target object and the variable item value a. The learning unit 193 performs learning of the model φ so that the inter-distribution distance between the distribution of the feature expressions 0 output by the model φ in response to input of the fixed value x for each estimation target object and the variable item value a included in the learning data and the distribution of the feature expressions Φ_{rand} output by the model φ in response to input of the fixed value for each estimation target object and the variable item value a randomly selected based on a uniform distribution is reduced.

According to the trained model φ by the learning device 100, the variable item value a included in the learning data is transformed into the feature expression Φ that shows the same distribution as the feature expression Φ, and in the case of the uniform distribution data a_{rand}. This allows the learning unit 193 to perform learning of the model h so that the model h reflects the relationship between the variable item value a and the estimation target item value yₐ included in the learning data, not only for the variable item value a indicated in the learning data, but for the entire distribution of the variable item value a. In this respect, the accuracy of the model f resulting from the combination of the model φ and the model h is expected to be high.

According to the learning device 100, in this respect, when fixed values and variable values are input to a model for each target of learning, it is possible to perform model training corresponding to those inputs.

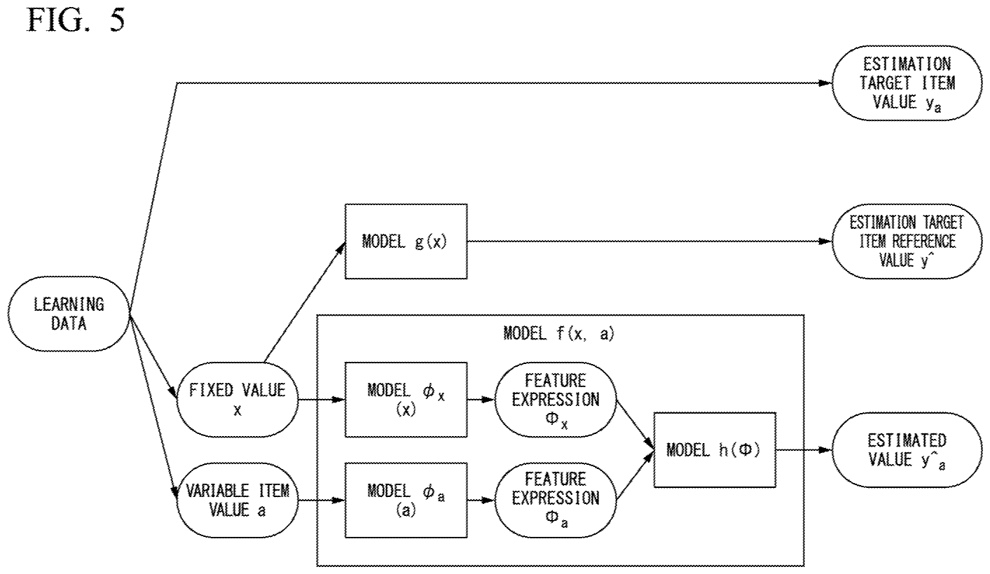

FIG. 5 is a diagram that shows a third example of the inputs and outputs of a model handled by the learning device 100.

In the example in FIG. 5, model φₓ receives an input of the fixed value x and outputs a feature expression. Model φₓ corresponds to an example of the first model. The feature expression output by the model φₓ is denoted as Φₓ. The feature expression D is data representing the feature of the fixed value x, which is the input data to the model φₓ. The feature expression Φ corresponds to an example of the first feature expression.

The model φₓ is also denoted as φₓ (x).

The model φₐ receives an input of variable item value a and outputs a feature expression. Model φₐ corresponds to an example of the second model. The feature expression output by the model φₐ is denoted as Φₐ. The feature expression Φₐ is data representing the feature of the variable item value a, which is the input data to the model φₐ. The feature expression Φₐ corresponds to an example of the second feature expression.

The model φₐ is also denoted as φₐ (a).

In the example in FIG. 5, model h outputs estimated value y′ a in response to receiving the input of the feature expression Φ resulting from the combination of the feature expression Φ and the feature expression Φₐ.

The combination of model φₓ, model φₐ, and model h constitutes model f.

The learning unit 193 performs learning of at least one of the model φₓ and the model φₐ so that the feature expression φₓ and the feature expression φₐ are independent as random variables.

This yields a distribution of feature expression Φₐ that does not depend on the value of the fixed value x. Accordingly, it is considered that the model φₐ extracts a feature that does not depend on the fixed value x from the variable item value a obtained in combination with the fixed value x in the measurement data, and outputs it as the feature expression φₐ. This allows the learning unit 193 to perform learning of the model h so that the model h reflects the relationship between the variable item value a and the estimation target item value yₐ included in the learning data, not only for the variable item value a for each fixed value x indicated in the learning data, but for the entire distribution of the variable item value a. In this respect, the accuracy of model f resulting from the combination of the model φₓ and the model φₐ is expected to be high.

The method by which the learning unit 193 performs learning of at least one of the model φₓ and the model φₐ so that the feature expression φₓ and the feature expression φₐ are independent as random variables is not limited to any particular method. For example, the learning unit 193 may perform learning of at least one of the model φₓ and the model φₐ so that the Hilbert-Schmidt Independence Criterion (HSIC) becomes smaller. Moreover, for example, the learning unit 193 may perform learning of the model φ to minimize the inter-distribution distance using an evaluation function that includes the inter-distribution distance of the distribution of the feature expression Φ and the distribution of the feature expression Φ_{rand}. The learning unit 193 may perform learning of the model φ such that the inter-distribution distance between the distribution of the feature expression Φ and the distribution of the feature expression Φ_{rand} is equal to or less than a predetermined threshold.

The HSIC in this case is as shown in Expression (7).

[Expression 7]

HSIC({ϕₓ(x)},{ϕₐ(a)}) (7)

“HSIC” denotes the value of the Hilbert-Schmidt Independence Criterion. “{φₓ(x)}” denotes the set of feature expressions Φₓ output by the model φₓ. The “{φₐ(a)}” denotes the set of feature expression Φₐ output by the model φₐ. As described above, the model φₓ outputs the feature expression Φₓ for the input of the fixed value x of each estimation target object. The model φₐ outputs the feature expression Φₐ for an input of the variable item value a. The learning unit 193 uses an evaluation function including an evaluation index of the independence between the distribution of the feature expression Φ and the distribution of the feature expression Φₐ to perform learning of at least one of the model φₓ or the model φ so that the independence indicated by the evaluation index becomes higher.

This yields a distribution of the feature expressions Φₐ that does not depend on the value of the fixed value x. Accordingly, it is considered that the model φₐ extracts a feature that does not depend on the fixed value x from the variable item value a obtained in combination with the fixed value x in the measurement data, and outputs it as the feature expression φₐ. This allows the learning unit 193 to perform learning of the model h so that the model h reflects the relationship between the variable item value a and the estimation target item value yₐ included in the learning data, not only for the variable item value a for each fixed value x indicated in the learning data, but for the entire distribution of the variable item value a. In this respect, the accuracy of model f resulting from the combination of the model φₓ, the model φₐ and the model h is expected to be high.

According to the learning device 100, in this respect, when fixed values and variable values are input to a model for each target of learning, it is possible to perform model training corresponding to those inputs.

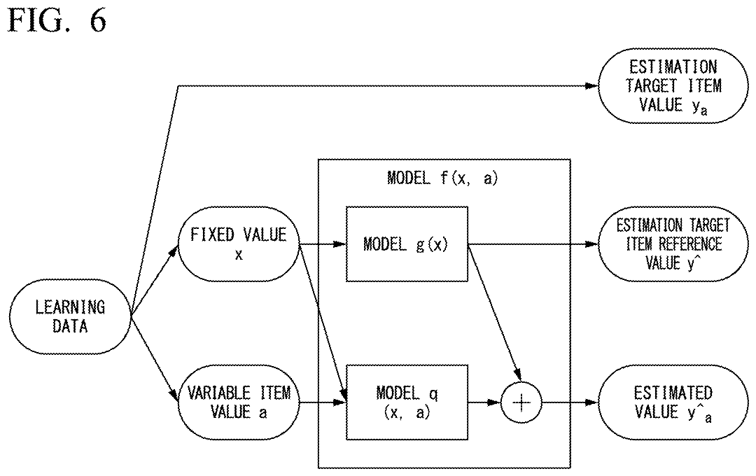

FIG. 6 is a diagram that shows a fourth example of the inputs and outputs of the model handled by the learning device 100.

In the example of FIG. 6, the model q receives inputs of the fixed value x and the variable item value a, and outputs a value corresponding to the difference obtained by subtracting the estimation target item reference value y\hat{ } from the estimated value y\hat{ }ₐ. The output of model q is denoted as rₐ. The estimation target item reference value y\hat{ }is represented by the output of the model g as “g(x)”, and rₐ is shown as follows in Expression (8).

[Expression 8]

rₐ=yₐ−g(x) (8)

The model q is also denoted as q(x,a).

The additive model, indicated by “+” in FIG. 6, adds the output of model g(x) and the output of model q(x,a). The output of the additive model corresponds to the estimated value y\hat{ }ₐ.

The model f is constructed by combining the model g, the model q, and the additive model.

In this case, the model f is shown as in Expression (9).

[Expression 9]

f(x,a)=g(x)+q(x,a) (9)

Here, the model g can be viewed as a conditional mean of the estimated value y\hat{ }ₐ under the condition of each estimation target object represented by the fixed value x, and is expressed as Expression (10).

[Expression 10]

g(x)≅E_{a˜μ(a|x)}[yₐ|x] (10)

“E” denotes the expected value. “a˜μ(a|x)” indicates that the distribution of the variable item values a follows the distribution according to the fixed values x (the distribution of the variable item values a in the learning data). “E[yₐ|x]” represents the expected value of the estimation target item value yₐ for the variable item value a conditioned on the fixed value x.

In the example in FIG. 6, the model g can ideally be regarded as outputting the value of the portion of the estimated value y\hat{ }ₐ that does not depend on the variable item value a based on the fixed value x of each estimation target object. The model q can then ideally be regarded as outputting the value of the portion of the estimated value y\hat{ }ₐ that depends on both the fixed value x of each estimation target object and the variable item value a, as a correction value for the output of the model g.

The learning data acquisition unit 192 calculates the value rₐ, which is obtained by subtracting from the estimation target item value yₐ included in a sample of learning data the output of model g in that sample as shown in Expression (8), and generates the learning data in which the estimation target item value yₐ is replaced with the calculated value rₐ.

The learning unit 193 uses the learning data generated by the learning data acquisition unit 192 to perform learning of the model q so as to output the value rₐ, which is obtained by subtracting from the estimation target item value yₐ included in a sample of learning data the output of model g in that sample, as shown in Expression (8).

Here, in learning the entire model f, which is affected by both the fixed value x and the variable item value a, it is considered that it may not be possible to obtain a sufficient number of samples and perform accurate learning because the input data space is a large and complex function. For example, as explained with reference to FIG. 3, it is considered that the variable item value a, which is not shown in the learning data, cannot adequately reflect the learning data.

In contrast, the model g receives no input of the variable item value a. Moreover, since the model q is only required to predict the value r a for which the influence of the fixed value x is excluded to a certain extent in advance, it is considered that a model expressed in terms of a simple function can provide sufficient approximation accuracy compared to the case of the model f. In this respect, it is expected that the learning unit 193 can perform learning of model g and model q with greater accuracy.

Here, the function being simple may refer to the sum of squares of the parameters being small when the function is expressed as a neural network. Also, the function being simple here may refer to a function that is p-Lipschitz continuous with respect to a small constant ρ.

The learning unit 193 can also perform learning of models g and f by supervised learning, and in this respect, it is expected that learning can be performed with high accuracy and that the load on the learning unit 193 is relatively small.

The learning unit 193 first performs learning of the model g using the learning data. After the learning unit 193 completes the learning of the model g, the model calculation unit 191 calculates the estimation target item reference value y\hat{ } for each sample of learning data, and the learning data acquisition unit 192 generates learning data in which the estimation target item value yₐ for that sample is replaced by the difference rₐ. The learning unit 193 performs learning of the model q using the learning data in which the estimation target item value yₐ is replaced by the difference rₐ.

As described above, the model calculation unit 191 calculates the estimation target item reference value y\hat{ }according to the fixed value x of each estimation target object, using the model g. The learning data acquisition unit 192 acquires learning data that includes the fixed value x of each estimation target object, the variable item value a, and the difference r a obtained by subtracting the estimation target item reference value y\hat{ } from the estimation target item value y\hat{ }ₐ according to that fixed value x and that variable item value a. The learning unit 193 performs learning of the model q using the learning data acquired by the learning data acquisition unit 192. The model q outputs an estimated value of the difference rₐ, which is obtained by subtracting the estimation target item reference value y\hat{ } from the estimation target item value y\hat{ }ₐ in response to the input of the fixed value x of each estimation target object and the variable item value a.

It is conceivable that the correlation between the fixed value x and the output of the model is lower (smaller) in the case of the model q receiving inputs of the fixed value x and the variable item value a and outputting the difference rₐ, than the model f receiving inputs of the fixed value x and the variable item value a and outputting the estimation target item value y\hat{ }ₐ. This suggests that a sufficient approximation accuracy can be obtained with the model q using a model expressed in terms of a simple function compared to the case of the model f.

If the effect of the fixed value x on the estimation target item value y\hat{ }ₐ is large and the effect of the variable item value a is relatively small, the hypothesis space of model q may be particularly small. An example of a case in which the effect of variable item value a is relatively small is when the estimation target object is a store, such as a retail store, as described above, and the effect of fixed value x, such as the location of the store, on sales corresponding to the estimation target item value y\hat{ }ₐ is large while the effect of product assortment, corresponding to the variable item value a, is relatively small.

Thus, the relatively small hypothesis space of model q is expected to allow the learning unit 193 to perform learning of model q with relatively high accuracy, such that overlearning is relatively unlikely to occur.

According to the learning device 100, in this respect, when fixed values and variable values are input to a model for each target of learning, it is possible to perform model training corresponding to those inputs.

The learning unit 193 can perform learning of the model q by supervised learning using the difference r a as the correct answer. In this respect, it is also expected that the learning unit 193 can perform learning of the model q with relatively high accuracy.

Also, in the form f(x,a)=g(x)+q(x,a) as in Expression (8) above, where g(x) is trained to estimate a marginalized conditional expectation in relation to a over the data distribution, model q is expected to be robust with respect to the estimation error of model g. The “marginalized conditional expectation in relation to a over the data distribution” means the right side of Expression (10), i.e., “E_{a˜μ(a|x)}[yₐ|x]”. Robustness here is the small effect of a parameter estimation error in model g on the estimation of the parameters in model q. More specifically, robustness here is the small deterioration in the accuracy of the estimation of model q when the parameter estimate of model g changes slightly from the parameter representing the true function.

In the case of an application where the product assortment is determined so that sales are large for a single store, the estimation target item reference value y\hat{ }output by model g is unnecessary, and the difference rₐ output by the model q is all that is needed. In this respect, the accuracy of the estimation of g(x) itself is not an issue.

Also for model g, since the hypothesis space is relatively small and supervised learning can be used for learning, it is expected that the learning unit 193 can perform learning of model g with relatively high accuracy. In this regard, when the model calculation unit 191 calculates the estimated value y\hat{ }ₐ based on Expression (8) using the model g, it is expected to be able to calculate the estimated value y\hat{ }ₐ with high accuracy.

The learning device 100 may perform any one of the learning method using the model shown in FIG. 2, the learning method using the model shown in FIG. 3, and the learning method using the model shown in FIG. 5. The learning device 100 may combine two or more of the learning method using the model shown in FIG. 2, the learning method using the model shown in FIG. 3, and the learning method using the model shown in FIG. 5 and perform it.

The learning method here, which uses the model shown in FIG. 2, involves performing learning of the model f so that the value of ER in Expression (1) becomes smaller. The learning method using the model shown in FIG. 3 is a learning method that includes performing learning of the model φ so that the inter-distribution distance between the distribution of feature expressions 0 and the distribution of feature expressions is reduced. The learning method using the model shown in FIG. 5 is a learning method that includes performing learning of the model q using learning data that includes the difference rₐ.

The learning device 100 may perform either one of the learning method using the model shown in FIG. 2 and the learning method using the model shown in FIG. 6. The learning device 100 may combine the learning method using the model shown in FIG. 2 and the learning method using the model shown in FIG. 6 and perform it.

The learning method using the model shown in FIG. 6 here is a learning method that includes performing learning of model q using learning data that includes the difference rₐ shown in Expression (8).

The models that the learning device 100 targets for learning are not limited to models of a particular method.

For example, any one or more of model f, model g, model φ, model h, model φₓ, model φₐ, and model q may be constructed using a neural network. Alternatively, any one or more of model f, model g, model φ, model h, model φₓ, model φₐ, and model q may be presented as mathematical formulas, logical expressions, or combinations thereof.

Any one or more of model f, model g, model φ, model h, model φₓ, model φₐ, and model q may be stored by the model storage unit 181. Any one or more of model f, model g, model φ, model h, model φₓ, model φₐ, and model q may be constituted using dedicated hardware separate from the learning device 100.

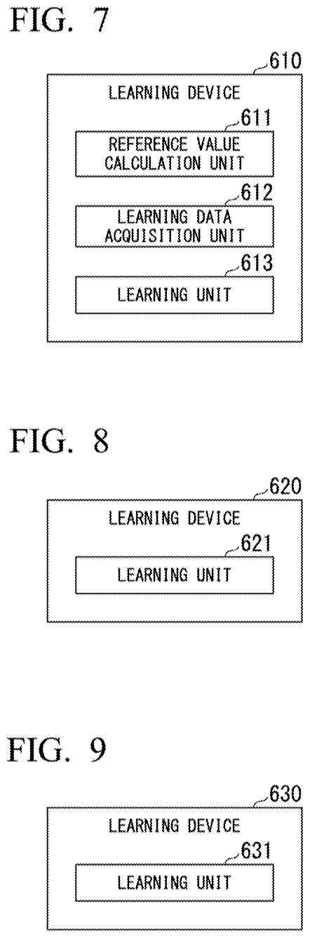

FIG. 7 is a diagram showing a second example of the configuration of the learning device according to the example embodiment. In the configuration shown in FIG. 7, the learning device 610 includes a reference value calculation unit 611, a learning data acquisition unit 612, and a learning unit 613.

In such a configuration, the reference value calculation unit 611 calculates the estimation target item reference value according to the fixed value of each estimation target object. The learning data acquisition unit 612 acquires learning data that includes a fixed value of each estimation target object, a variable item value, and the estimation target item value according to that fixed value and that variable item value. The learning unit 613 performs learning of a model that outputs an estimated value of the estimation target item value in response to input of a fixed value of each estimation target object and a variable item value, using the learning data acquired by the learning data acquisition unit 612 and an evaluation function that gives a higher evaluation when the estimated value is equal to or greater than the estimation target item reference value and the estimation target item value is equal to or greater than the estimation target item reference value, and when the estimated value is less than the estimation target item reference value and the estimation target item value is less than the estimation target item reference value.

The reference value calculation unit 611 corresponds to an example of a reference value calculation means. The learning data acquisition unit 612 corresponds to an example of a learning data acquisition means. The learning unit 613 corresponds to an example of a learning means.

According to the learning device 610, it is expected that the estimation target item value, which is the actual value, is unlikely to be small even though the estimated value output by the model is large. In this respect, according to the learning device 610, when a fixed value and a variable value are input to the model for each learning target, model learning can be performed corresponding to the input.

The reference value calculation unit 611 can be performed, for example, using the functions of the model calculation unit 191 shown in FIG. 1. The learning data acquisition unit 612 can be performed, for example, using the functions of the learning data acquisition unit 192 shown in FIG. 1. The learning unit 613 can be realized, for example, using the functions of the learning unit 193 shown in FIG. 1.

FIG. 8 is a diagram showing a third example of the configuration of the learning device according to the example embodiment. In the configuration shown in FIG. 8, a learning device 620 includes a learning unit 621.

In such a configuration, the learning unit 621 performs learning of a model that outputs a feature expression in response to input of the fixed value of each estimation target object and the variable item value so that the inter-distribution distance between the distribution of feature expressions output by the model in response to input of the fixed value of each estimation target object and the variable item value included in the learning data and the distribution of feature expressions output by the model in response to input of the fixed value of each estimation target object and the variable item value randomly selected based on a uniform distribution is reduced.

The learning unit 621 corresponds to an example of a learning means.

According to the model trained by the learning device 620, the variable item values included in the learning data are transformed into feature expressions that show the same distribution as the feature expressions in the case of variable item values being randomly selected based on a uniform distribution. Feature expressions obtained based on learning data can be used to performing learning of a model that receives inputs of feature expressions and outputs estimation target item values. Thereby, learning can be performed not only for the variable item values indicated in the learning data, but for the entire distribution of the variable item values so that the relationship between the variable item values and the estimation target item values included in the training data is reflected in the model that receives feature representation input and outputs the estimation target item values. According to the learning device 620, in this regard, the combination of the two models described above, which outputs the estimation target item value in response to input of a fixed value of each estimation target object and variable item value, is expected to be highly accurate. In this respect, according to the learning device 620, when a fixed value and a variable value are input to the model for each learning target, model learning can be performed corresponding to the input.

The learning unit 621 can be realized, for example, using the functions of the learning unit 193 shown in FIG. 1.

FIG. 9 is a diagram showing a fourth example of the configuration of the learning device according to the example embodiment. In the configuration shown in FIG. 9, a learning device 630 includes a learning unit 631.

In such a configuration, the learning unit 631 uses an evaluation function including an evaluation index of the independence between the distribution of a first feature expression output by a first model in response to input of a fixed value of each estimation target object and the distribution of a second feature expression output by a second model in response to input of a variable item value to perform learning of at least one of the first model or the second model so that the independence indicated by the evaluation index becomes higher.

The learning unit 631 corresponds to an example of a learning means.

According to the second model, which has already been trained by the learning device 630, a distribution of feature expressions that does not depend on fixed values can be obtained. Accordingly, it is considered that the second model extracts a feature that does not depend on the fixed value from the variable item value obtained in combination with the fixed value in the measurement data, and outputs it as the feature expression. Thereby, learning can be performed not only for the variable item values for each fixed value indicated in the learning data, but for the entire distribution of the variable item values so that the relationship between the variable item values and the estimation target item values included in the learning data is reflected in the model that receives the input of the first and second feature expressions and outputs the estimation target item values. According to the learning device 630, in this regard it is expected that the accuracy of the model that outputs the estimation target item value in response to the input of the fixed value of each estimation target object and the variable item value by the combination of the first model, the second model, and the model that receives the inputs of the first and second feature expressions and outputs the estimation target item value will be high.

In this respect, according to the learning device 630, when a fixed value and a variable value are input to the model for each learning target, model learning can be performed corresponding to the input.

The learning unit 631 can be realized, for example, using the functions of the learning unit 193 shown in FIG. 1.

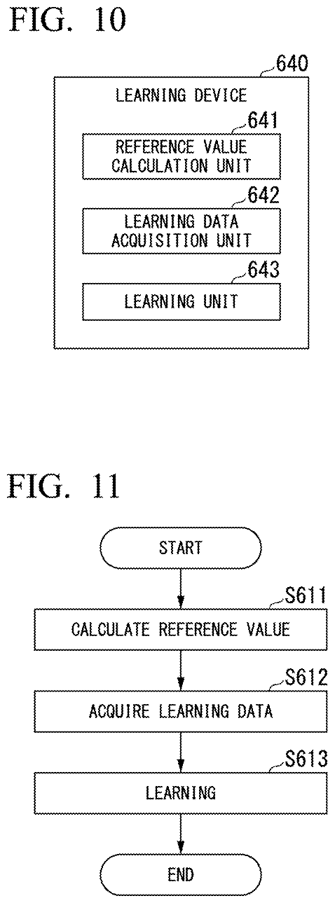

FIG. 10 is a diagram showing a fifth example of the configuration of the learning device according to the example embodiment. In the configuration shown in FIG. 10, the learning device 640 includes a reference value calculation unit 641, a learning data acquisition unit 642, and a learning unit 643.

In such a configuration, the reference value calculation unit 641 calculates the estimation target item reference value according to the fixed value of each estimation target object. The learning data acquisition unit 642 acquires learning data that includes the fixed value of each estimation target object, the variable item value, and the difference obtained by subtracting the estimation target item reference value from the estimation target item value according to that fixed value and that variable item value. The learning unit 643 uses the learning data acquired by the learning data acquisition unit 642 to perform learning of a model that outputs an estimated value of the difference obtained by subtracting the estimation target item reference value from the estimation target item value in response to the input of the fixed value of each estimation target object and the variable item value.

The reference value calculation unit 641 corresponds to an example of a reference value calculation means. The learning data acquisition unit 642 corresponds to an example of a learning data acquisition means. The learning unit 643 corresponds to an example of a learning means.

It is conceivable that, by receiving the inputs of the fixed value and variable item value to calculate the estimated value of the difference obtained by subtracting the estimation target item reference value from the estimation target item value, the correlation between the fixed value and the output of the model is lower (smaller) than the case of receiving the inputs of the fixed value and variable item value and outputting the estimation target item value. This suggests that the hypothetical space of the model is relatively small.

Thus, the relatively small hypothesis space of the model is expected to allow the learning unit 643 to perform learning of model with relatively high accuracy, such that overlearning is relatively unlikely to occur. In this respect, according to the learning device 640, when a fixed value and a variable value are input to the model for each learning target, model learning can be performed corresponding to the input.

The learning unit 643 can perform learning of the model by supervised learning, in which the difference obtained by subtracting the estimation target item reference value from the estimation target item value is used as the correct answer. In this respect, it is also expected that the learning unit 643 can perform learning of the model with relatively high accuracy.

The estimated value can be calculated by summing the output of the model that receives fixed and variable item value inputs and calculates the estimated value of the difference obtained by subtracting the estimation target item reference value from the estimation target item value, and the output of the model that receives fixed and variable item value inputs and calculates the estimation target item reference value.

In this case, it is expected that the learning of the model that receives fixed and variable item value inputs and calculates the estimated value of the difference obtained by subtracting the estimation target item reference value from the estimation target item value is robust to the estimation error of the model that receives fixed and variable item value inputs and calculates the estimation target item reference value.

In the case of an application where one wants to determine a variable item value for one estimation target object that will result in a larger estimation target item value, it is not necessary to actually calculate the estimation target item value, but only to determine the variable item value so that the difference output by the model becomes larger. In this regard, the estimation error of model g does not directly affect the performance of determining variable item values.

Moreover, since the model that receives fixed and variable item value inputs and calculates the estimation target item reference value has a relatively small hypothesis space and can be learned by supervised learning, it is expected that the learning of this model can be performed with relatively high accuracy. In this respect, when calculating the estimated value by summing the output of the model that receives fixed and variable item value inputs and calculates the estimated value of the difference obtained by subtracting the estimation target item reference value from the estimation target item value, and the output of the model that receives fixed and variable item value inputs and calculates the estimation target item reference value, it is expected that the estimated value can be calculated with high accuracy.

The reference value calculation unit 641 can be realized, for example, using the functions of the model calculation unit 191 shown in FIG. 1. The learning data acquisition unit 642 can be realized, for example, using the functions of the learning data acquisition unit 192 shown in FIG. 1. The learning unit 643 can be realized, for example, using the functions of the learning unit 193 shown in FIG. 1.

FIG. 11 is a flowchart showing a first example of the processing procedure in the learning method according to the example embodiment. The learning method shown in FIG. 11 includes calculating the reference value (Step S611), acquiring the learning data (Step S612), and performing learning (Step S613).

In calculating the reference value (Step S611), the estimation target item reference value is calculated according to the fixed value of each estimation target object.

In acquiring learning data (Step S612), learning data including the fixed value of each estimation target object, the variable item value, and the estimation target item value according to the fixed value and the variable item value are acquired.

In performing learning (Step S613), learning of a model that outputs an estimated value of the estimation target item value in response to inputs of a fixed value for each estimation target object and a variable item value is performed using learning data and an evaluation function that gives a higher evaluation when the estimated value is equal to or greater than the estimation target item reference value and the estimation target item value is equal to or greater than the estimation target item reference value, and when the estimated value is less than the estimation target item reference value and the estimation target item value is less than the estimation target item reference value.

According to the method shown in FIG. 11, it is expected that the estimation target item value, which is the actual value, is unlikely to be small even though the estimated value output by the model is large. In this respect, according to the method shown in FIG. 11, when a fixed value and a variable value are input to the model for each learning target, model learning can be performed corresponding to the input.

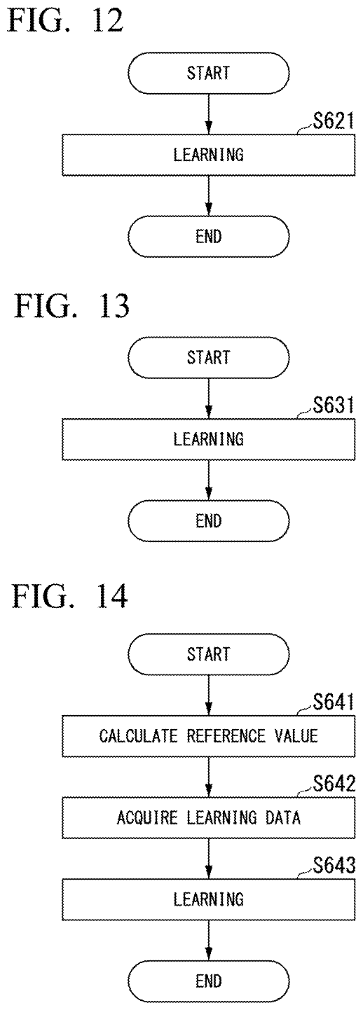

FIG. 12 is a flowchart showing a second example of the processing procedure in the learning method according to the example embodiment. The learning method shown in FIG. 12 includes performing learning (Step S621).

In performing learning (Step S621), learning of a model that outputs a feature expression for inputs of the fixed value of each estimation target object and the variable item value is performed so that the inter-distribution distance between the distribution of feature expressions output by the model in response to input of the fixed value of each estimation target object and the variable item value included in the learning data and the distribution of feature expressions output by the model in response to input of the fixed value of each estimation target object and the variable item value randomly selected based on a uniform distribution is reduced.

According to the model trained by the method shown in FIG. 12, the variable item values included in the learning data are transformed into feature expressions that show the same distribution as the feature expressions in the case of variable item values being randomly selected based on a uniform distribution. Feature expressions obtained based on learning data can be used to perform learning of a model that receives inputs of feature expressions and outputs estimation target item values. Thereby, learning can be performed not only for the variable item values indicated in the learning data, but for the entire distribution of the variable item values so that the relationship between the variable item values and the estimation target item values included in the training data is reflected in the model that receives feature representation input and outputs the estimation target item values. According to the method shown in FIG. 12, in this regard, the combination of the two models described above, which outputs the estimation target item values in response to input of the fixed value of each estimation target object and the variable item value, is expected to be highly accurate. In this respect, according to the method shown in FIG. 12, when a fixed value and a variable value are input to the model for each learning target, model learning can be performed corresponding to the input.

FIG. 13 is a flowchart showing a third example of the processing procedure in the learning method according to the example embodiment. The learning method shown in FIG. 13 includes performing learning (Step S631).

In performing learning (Step S631), using an evaluation function including an evaluation index of the independence between the distribution of a first feature expression output by a first model in response to input of a fixed value of each estimation target object and the distribution of the second feature expression output by a second model in response to input of a variable item value, at least one of the first model or the second model is trained so that the independence indicated by the evaluation index becomes higher.

According to the second model trained by the method shown in FIG. 13, a distribution of feature expressions that does not depend on fixed values can be obtained. Accordingly, it is considered that the second model extracts a feature that does not depend on the fixed value from the variable item value obtained in combination with the fixed value in the measurement data, and outputs it as the feature expression. Thereby, learning can be performed not only for the variable item values for each fixed value indicated in the learning data, but for the entire distribution of the variable item values so that the relationship between the variable item values and the estimation target item values included in the learning data is reflected in the model that receives the input of the first and second feature expressions and outputs the estimation target item values. According to the method shown in FIG. 13, in this regard it is expected that the accuracy of the model that outputs the estimation target item value in response to the input of the fixed value of each estimation target object and variable item value by the combination of the first model, the second model, and the model that receives the inputs of the first and second feature expressions and outputs the estimation target item value will be high.

In this respect, according to the method shown in FIG. 13, when a fixed value and a variable value are input to the model for each learning target, model learning can be performed corresponding to the input.

FIG. 14 is a flowchart showing a fourth example of the processing procedure in the learning method according to the example embodiment. The learning method shown in FIG. 14 includes calculating the reference value (Step S641), acquiring the learning data (Step S642), and performing learning (Step S643).

In calculating the reference value (Step S641), the estimation target item reference value is calculated according to the fixed value of each estimation target object.

In acquiring learning data (Step S642), learning data that includes the fixed value of each estimation target object, the variable item value, and the difference obtained by subtracting the estimation target item reference value from the estimation target item value according to that fixed value and that variable item value are acquired.

In performing learning (Step S643), the learning data is used to output an estimated value of the difference obtained by subtracting the estimation target item reference value from the estimation target item value in response to the input of the fixed value of each estimation target object and the variable item value.

According to the method shown in FIG. 14, it is conceivable that, by receiving the inputs of the fixed value and variable item value to calculate the estimated value of the difference obtained by subtracting the estimation target item reference value from the estimation target item value, the correlation between the fixed value and the output of the model is lower than the case of receiving the inputs of the fixed value and variable item value and outputting the estimation target item value. This suggests that the hypothetical space of the model is relatively small.

Thus, the relatively small hypothesis space of the model is expected to allow for relatively high accuracy in learning the model, such as by making overlearning relatively unlikely to occur. In this respect, according to the method shown in FIG. 14, when a fixed value and a variable value are input to the model for each learning target, model learning can be performed corresponding to the input.

According to the method shown in FIG. 14, the model can be trained by supervised learning, in which the difference obtained by subtracting the estimation target item reference value from the estimation target item value is used as the correct answer. In this respect, it is also expected that the model can be trained with relatively high accuracy.

The estimated value can be calculated by summing the output of the model that receives fixed and variable item value inputs and calculates the estimated value of the difference obtained by subtracting the estimation target item reference value from the estimation target item value, and the output of the model that receives fixed and variable item value inputs and calculates the estimation target item reference value.

In this case, it is expected that the learning of the model that receives fixed and variable item value inputs and calculates the estimated value of the difference obtained by subtracting the estimation target item reference value from the estimation target item value is robust to the estimation error of the model that receives fixed and variable item value inputs and calculates the estimation target item reference value.

In the case of an application where one wants to determine a variable item value for one estimation target object that will result in a larger estimation target item value, it is not necessary to actually calculate the estimation target item value, but only to determine the variable item value so that the difference output by the model becomes larger. In this regard, the estimation error of model g does not directly affect the performance of determining variable item values.

Moreover, since the model that receives fixed and variable item value inputs and calculates the estimation target item reference value has a relatively small hypothesis space and can be trained by supervised learning, it is expected that the training of this model can be performed with relatively high accuracy. In this respect, when calculating the estimated value by summing the output of the model that receives fixed and variable item value inputs and calculates the estimated value of the difference obtained by subtracting the estimation target item reference value from the estimation target item value, and the output of the model that receives fixed and variable item value inputs and calculates the estimation target item reference value, it is expected that the estimated value can be calculated with high accuracy.

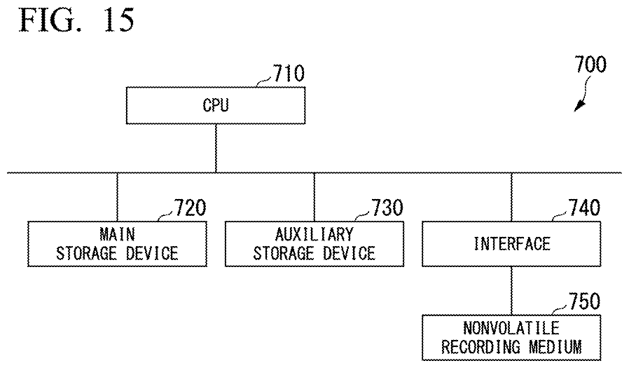

FIG. 15 is a schematic block diagram showing the configuration of the computer according to at least one example embodiment.

In the configuration shown in FIG. 15, a computer 700 includes a CPU 710, a main storage device 720, an auxiliary storage device 730, an interface 740, and a nonvolatile recording medium 750.

Any one or more of the above learning devices 100, 610, 620, 630 and 640, or portions thereof, may be implemented in the computer 700. In that case, the operations of each of the above-mentioned processing units are stored in the auxiliary storage device 730 in the form of a program. The CPU 710 reads the program from the auxiliary storage device 730, deploys the program in the main storage device 720, and executes the above processing according to the program. The CPU 710 also reserves a memory area corresponding to each of the above-mentioned storage units in the main storage device 720 according to the program. Communication between each device and other devices is performed by the interface 740, which has a communication function and communicates according to the control of the CPU 710. The interface 740 also has a port for the nonvolatile recording medium 750 and reads information from and writes information to the nonvolatile recording medium 750.

When the learning device 100 is implemented in the computer 700, the operation of the control unit 190 and the various parts thereof are stored in the auxiliary storage device 730 in the form of a program. The CPU 710 reads the program from the auxiliary storage device 730, deploys the program in the main storage device 720, and executes the above processing according to the program.

The CPU 710 also reserves a storage area corresponding to the storage portion 180 and each part thereof in the main storage device 720 according to the program.

Communication with other devices by the communication unit 110 is performed by the interface 740, which has a communication function and operates according to the control of the CPU 710.

The display by the display unit 120 is performed by the interface 740 having a display device and displaying various images according to the control of the CPU 710.

Reception of user operations by the operation input unit 130 is performed by the interface 740 having input devices such as a keyboard and mouse, for example, to receive user operations and output information indicating received user operations to the CPU 710.

When the learning device 610 is implemented in the computer 700, the operations of the reference value calculation unit 611, the learning data acquisition unit 612, and the learning unit 613 are stored in the auxiliary storage device 730 in the form of programs. The CPU 710 reads the program from the auxiliary storage device 730, deploys the program in the main storage device 720, and executes the above processing according to the program.

The CPU 710 also reserves storage space in the main storage device 720 for the processing performed by the learning device 610 according to the program.

Communication between the learning device 610 and other devices is performed by the interface 740, which has a communication function and operates according to the control of the CPU 710.

The interaction between the learning device 610 and the user is performed by the interface 740 having input and output devices, presenting information to the user with the output devices and receiving user operations with the input devices according to the control of the CPU 710.

When the learning device 620 is implemented in the computer 700, the operations of the learning unit 621 are stored in the auxiliary storage device 730 in the form of a program. The CPU 710 reads the program from the auxiliary storage device 730, deploys the program in the main storage device 720, and executes the above processing according to the program.

The CPU 710 also reserves storage space in the main storage device 720 for the processing performed by the learning device 620 according to the program.

Communication between the learning device 620 and other devices is performed by the interface 740, which has a communication function and operates according to the control of the CPU 710.

The interaction between the learning device 620 and the user is performed by the interface 740 having input and output devices, presenting information to the user with the output devices and receiving user operations with the input devices according to the control of the CPU 710.

When the learning device 630 is implemented in the computer 700, the operations of the learning unit 631 are stored in the auxiliary storage device 730 in the form of a program. The CPU 710 reads the program from the auxiliary storage device 730, deploys the program in the main storage device 720, and executes the above processing according to the program.

The CPU 710 also reserves storage space in the main storage device 720 for the processing performed by the learning device 630 according to the program.

Communication between the learning device 630 and other devices is performed by the interface 740, which has a communication function and operates according to the control of the CPU 710.

The interaction between the learning device 630 and the user is performed by the interface 740 having input and output devices, presenting information to the user with the output devices and receiving user operations with the input devices according to the control of the CPU 710.

Any one or more of the programs described above may be recorded on the nonvolatile recording medium 750. In this case, the interface 740 may read the program from the nonvolatile recording medium 750. The CPU 710 may either directly execute the program read by the interface 740, or save the program once to the main memory 720 or the auxiliary memory 730 and then executed.

A program for executing all or some of the processes performed by the learning devices 100, 610, 620, 630, and 640 may be recorded on a computer-readable recording medium, and the program recorded on this recording medium may be read into a computer system and executed, whereby the processing of each part may be executed. The term “computer system” here shall include the operating system and hardware such as peripherals.

In addition, a “computer-readable recording medium” means a portable medium such as a flexible disk, magneto-optical disk, ROM (Read Only Memory), CD-ROM (Compact Disc Read Only Memory), or other storage device such as a hard disk built into a computer system. The above program may be used to realize some of the aforementioned functions, and may also be used to realize the aforementioned functions in combination with a program already recorded in the computer system.

While the above example embodiments of this invention have been described in detail with reference to the drawings, specific configurations are not limited to these example embodiments, and designs and the like within a range that do not depart from the gist of this invention are also included.

Some or all of the above example embodiments may also be described as, but not limited to, the following supplementary notes.

(Supplementary Note 1)

A learning device comprising:

a reference value calculation means that calculates an estimation target item reference value according to a fixed value of each estimation target object;

a learning data acquisition means that acquires learning data that includes the fixed value of each estimation target object, a variable item value, and an estimation target item value according to the fixed value and the variable item value; and

a learning means that trains, using the learning data and an evaluation function, a model that outputs an estimated value of the estimation target item value in response to input of the fixed value of each estimation target object and the variable item value, the evaluation function giving a high evaluation when the estimated value is equal to or greater than the estimation target item reference value and the estimation target item value is equal to or greater than the estimation target item reference value, and when the estimated value is less than the estimation target item reference value and the estimation target item value is less than the estimation target item reference value.

(Supplementary Note 2)

The learning device according to supplementary note 1, wherein the reference value calculation means calculates the estimation target item reference value using a model that outputs an estimated value of the estimation target item value in response to input of the fixed value of each estimation target object by training using the fixed value of each estimation target object and the estimation target item value as learning data.

(Supplementary Note 3)

The learning device according to supplementary note 1 or 2, wherein the learning means uses the evaluation function that includes a product of: a step function that takes a value corresponding to whether the estimation target item value is equal to or greater than the estimation target item reference value or whether the estimation target item value is less than the estimation target item reference value; and a monotonic and differentiable function in relation to a difference between an output of the model in response to inputs of the fixed value for each estimation target object and the variable item value and the estimation target item reference value.

(Supplementary Note 4)

The learning device according to any one of supplementary notes 1 to 3, wherein the learning means trains a model that outputs a feature expression in response to input of a fixed value for each estimation target object and a variable item value so that an inter-distribution distance between distribution of feature expressions output by the model in response to an input of the fixed value for each estimation target object and the variable item value included in the learning data and distribution of feature expressions output by the model in response to an input of the fixed value for each estimation target object and the variable item value randomly selected based on a uniform distribution is reduced.

(Supplementary Note 5)

The learning device according to any one of supplementary notes 1 to 4, wherein the learning means uses an evaluation function including an evaluation index of independence between distribution of a first feature expression output by a first model in response to an input of the fixed value for each estimation target object and distribution of a second feature expression output by a second model in response to an input of a variable item value to train at least one of the first model or the second model so that the independence indicated by the evaluation index becomes higher.

(Supplementary Note 6)

The learning device according to any one of supplementary notes 1 to 5, wherein the learning data acquisition means further acquires learning data that includes a fixed value for each estimation target object, a variable item value, and a difference between: an estimation target item value according to the fixed value and the variable item value; and the estimation target item reference value, and

the learning means uses the learning data that includes the fixed value for each estimation target object, the variable item value, and the difference between the estimation target item value according to that fixed value and that variable item value according to that fixed value and that variable item value and the estimation target item reference value to further train the model that outputs the estimated value of the difference between the estimation target item value and the estimation target item reference value for the input of the fixed value for each estimation target object and the variable item value.

(Supplementary Note 7)

The learning device according to supplementary note 6, wherein the reference value calculation means calculates the estimation target item reference value using a model that outputs an estimated value of the estimation target item value in response to an input of the fixed value of each estimation target object by training using the fixed value of each estimation target object and the estimation target item value as learning data.

(Supplementary Note 8)

A learning device comprising:

a learning means that trains a model that outputs a feature expression in response to an input of a fixed value for each estimation target object and a variable item value so that an inter-distribution distance between distribution of the feature expressions output by the model in response to an input of the fixed value for each estimation target object and the variable item value included in the learning data and distribution of the feature expressions output by the model in response to an input of the fixed value for each estimation target object and the variable item value randomly selected based on a uniform distribution is reduced.

(Supplementary Note 9)

A learning device comprising:

a learning means that uses an evaluation function including an evaluation index of independence between distribution of a first feature expression output by a first model in response to input of a fixed value for each estimation target object and distribution of a second feature expression output by a second model in response to input of a variable item value to train at least one of the first model or the second model so that the independence indicated by the evaluation index becomes higher.

(Supplementary Note 10)

A learning device comprising:

a reference value calculation means that calculates an estimation target item reference value according to a fixed value of each estimation target object;

a learning data acquisition means that acquires learning data that includes the fixed value for each estimation target object, a variable item value, and a difference between an estimation target item value according to the fixed value and the variable item value, and the estimation target item reference value; and

a learning means that trains, by using the learning data, a model that outputs an estimated value of the difference between the estimation target item value and the estimation target item reference value in response to an input of a fixed value for each estimation target object and a variable item value.

(Supplementary Note 11)

The learning device according to supplementary note 10, wherein the reference value calculation means calculates the estimation target item reference value using a model that outputs an estimated value of the estimation target item value in response to an input of the fixed value of each estimation target object by training using the fixed value of each estimation target object and the estimation target item value as learning data.

(Supplementary Note 12)

A learning method comprising:

calculating an estimation target item reference value according to a fixed value of each estimation target object;

acquiring learning data that includes the fixed value of each estimation target object, a variable item value, and an estimation target item value according to the fixed value and the variable item value; and

training, using the learning data and an evaluation function, a model that outputs an estimated value of the estimation target item value in response to input of the fixed value of each estimation target object and the variable item value, the evaluation function giving a high evaluation when the estimated value is equal to or greater than the estimation target item reference value and the estimation target item value is equal to or greater than the estimation target item reference value, and when the estimated value is less than the estimation target item reference value and the estimation target item value is less than the estimation target item reference value.

(Supplementary Note 13)

A learning method comprising:

training a model that outputs a feature expression in response to an input of a fixed value for each estimation target object and a variable item value so that an inter-distribution distance between distribution of the feature expressions output by the model in response to an input of the fixed value for each estimation target object and the variable item value included in the learning data and distribution of the feature expressions output by the model in response to an input of the fixed value for each estimation target object and the variable item value randomly selected based on a uniform distribution is reduced.

(Supplementary Note 14)

A learning method comprising:

using an evaluation function including an evaluation index of independence between distribution of a first feature expression output by a first model in response to input of a fixed value for each estimation target object and distribution of a second feature expression output by a second model in response to input of a variable item value to train at least one of the first model or the second model so that the independence indicated by the evaluation index becomes higher.

(Supplementary Note 15)

A learning method comprising:

calculating an estimation target item reference value according to a fixed value of each estimation target object;

acquiring learning data that includes the fixed value for each estimation target object, a variable item value, and a difference between an estimation target item value according to the fixed value and the variable item value, and the estimation target item reference value; and

outputting, by using the learning data, an estimated value of the difference between the estimation target item value and the estimation target item reference value in response to an input of a fixed value for each estimation target object and a variable item value.

(Supplementary Note 16)

A recording medium that stores a program for causing a computer to execute:

calculating an estimation target item reference value according to a fixed value of each estimation target object;

acquiring learning data that includes the fixed value of each estimation target object, a variable item value, and an estimation target item value according to the fixed value and the variable item value; and

training, using the learning data and an evaluation function, a model that outputs an estimated value of the estimation target item value in response to input of the fixed value of each estimation target object and the variable item value, the evaluation function giving a high evaluation when the estimated value is equal to or greater than the estimation target item reference value and the estimation target item value is equal to or greater than the estimation target item reference value, and when the estimated value is less than the estimation target item reference value and the estimation target item value is less than the estimation target item reference value.

(Supplementary Note 17)

A recording medium that stores a program for causing a computer to execute:

training a model that outputs a feature expression in response to an input of a fixed value for each estimation target object and a variable item value so that an inter-distribution distance between distribution of the feature expressions output by the model in response to an input of the fixed value for each estimation target object and the variable item value included in the learning data and distribution of the feature expressions output by the model in response to an input of the fixed value for each estimation target object and the variable item value randomly selected based on a uniform distribution is reduced.

(Supplementary Note 18)

A recording medium that stores a program for causing a computer to execute:

using an evaluation function including an evaluation index of independence between distribution of a first feature expression output by a first model in response to input of a fixed value for each estimation target object and distribution of a second feature expression output by a second model in response to input of a variable item value to train at least one of the first model or the second model so that the independence indicated by the evaluation index becomes higher.

(Supplementary Note 19)

A recording medium that stores a program for causing a computer to execute:

calculating an estimation target item reference value according to a fixed value of each estimation target object;

acquiring learning data that includes the fixed value for each estimation target object, a variable item value, and a difference between an estimation target item value according to the fixed value and the variable item value, and the estimation target item reference value; and

training, by using the learning data, a model that outputs an estimated value of the difference between the estimation target item value and the estimation target item reference value in response to an input of a fixed value for each estimation target object and a variable item value.

### DESCRIPTION OF REFERENCE SYMBOLS

100, 610, 620, 630, 640 Learning device
110 Communication unit
120 Display unit
130 Operation input unit
180 Storage unit
181 Model storage unit
190 Control unit
191 Model calculation unit
192, 612, 642 Learning data acquisition unit
193, 613, 621, 631, 643 Learning unit
611, 641 Reference value calculation unit

Priority is claimed on Japanese Patent Application No. 2021-031172, filed on Feb. 26, 2021, the content of which is incorporated herein by reference.

### INDUSTRIAL APPLICABILITY

The invention may be applied to a learning device, a learning method and a recording medium.

What is claimed is:

1. A learning device comprising:
a memory configured to store instructions; and
a processor configured to execute the instructions to:
calculate an estimation target item reference value according to a fixed value of each estimation target object;
acquire learning data that includes the fixed value of each estimation target object, a variable item value, and an estimation target item value according to the fixed value and the variable item value; and
train, using the learning data and an evaluation function, a model that outputs an estimated value of the estimation target item value in response to input of the fixed value of each estimation target object and the variable item value, the evaluation function giving a high evaluation when the estimated value is equal to or greater than the estimation target item reference value and the estimation target item value is equal to or greater than the estimation target item reference value, and when the estimated value is less than the estimation target item reference value and the estimation target item value is less than the estimation target item reference value.

2. The learning device according to claim 1, wherein the processor is configured to execute the instructions to calculate the estimation target item reference value using a model that outputs an estimated value of the estimation target item value in response to input of the fixed value of each estimation target object by training using the fixed value of each estimation target object and the estimation target item value as learning data.

3. The learning device according to claim 1, wherein the processor is configured to execute the instructions to use the evaluation function that includes a product of: a step function that takes a value corresponding to whether the estimation target item value is equal to or greater than the estimation target item reference value or whether the estimation target item value is less than the estimation target item reference value; and a monotonic and differentiable function in relation to a difference between an output of the model in response to inputs of the fixed value for each estimation target object and the variable item value and the estimation target item reference value.

4. The learning device according to claim 1, wherein the processor is configured to execute the instructions to train a model that outputs a feature expression in response to input of a fixed value for each estimation target object and a variable item value so that an inter-distribution distance between distribution of feature expressions output by the model in response to an input of the fixed value for each estimation target object and the variable item value included in the learning data and distribution of feature expressions output by the model in response to an input of the fixed value for each estimation target object and the variable item value randomly selected based on a uniform distribution is reduced.

5. The learning device according to claim 1, wherein the processor is configured to execute the instructions to use an evaluation function including an evaluation index of independence between distribution of a first feature expression output by a first model in response to an input of the fixed value for each estimation target object and distribution of a second feature expression output by a second model in response to an input of a variable item value to train at least one of the first model or the second model so that the independence indicated by the evaluation index becomes higher.

6. The learning device according to claim 1, wherein the processor is configured to execute the instructions to:
further acquire learning data that includes a fixed value for each estimation target object, a variable item value, and a difference between: an estimation target item value according to the fixed value and the variable item value; and the estimation target item reference value, and
use the learning data that includes the fixed value for each estimation target object, the variable item value, and the difference between the estimation target item value according to that fixed value and that variable item value according to that fixed value and that variable item value and the estimation target item reference value to further train the model that outputs the estimated value of the difference between the estimation target item value and the estimation target item reference value for the input of the fixed value for each estimation target object and the variable item value.

7. The learning device according to claim 6, wherein the processor is configured to execute the instructions to calculate the estimation target item reference value using a model that outputs an estimated value of the estimation target item value in response to an input of the fixed value of each estimation target object by training using the fixed value of each estimation target object and the estimation target item value as learning data.

8-11. (canceled)

12. A learning method comprising:
calculating an estimation target item reference value according to a fixed value of each estimation target object;
acquiring learning data that includes the fixed value of each estimation target object, a variable item value, and an estimation target item value according to the fixed value and the variable item value; and
training, using the learning data and an evaluation function, a model that outputs an estimated value of the estimation target item value in response to input of the fixed value of each estimation target object and the variable item value, the evaluation function giving a high evaluation when the estimated value is equal to or greater than the estimation target item reference value and the estimation target item value is equal to or greater than the estimation target item reference value, and when the estimated value is less than the estimation target item reference value and the estimation target item value is less than the estimation target item reference value.

13-15. (canceled)

16. A non-transitory recording medium that stores a program for causing a computer to execute:
calculating an estimation target item reference value according to a fixed value of each estimation target object;
acquiring learning data that includes the fixed value of each estimation target object, a variable item value, and an estimation target item value according to the fixed value and the variable item value; and
training, using the learning data and an evaluation function, a model that outputs an estimated value of the estimation target item value in response to input of the fixed value of each estimation target object and the variable item value, the evaluation function giving a high evaluation when the estimated value is equal to or greater than the estimation target item reference value and the estimation target item value is equal to or greater than the estimation target item reference value, and when the estimated value is less than the estimation target item reference value and the estimation target item value is less than the estimation target item reference value.

17-19. (canceled)
